(19) United States
(12) Patent Application Publication
(10) Pub. No.: US 2011/0051455 A1
(43) Pub. Date: Mar. 3, 2011

(54) ILLUMINATION PANEL

(75) Inventors: Hiroaki Matsuda, Kawasaki (JP); Tatsuhito Araki, Kawasaki (JP); Hiroaki Sakashita, Kawasaki (JP); Takehisa Ishikawa, Kawasaki (JP); Takashi Suzuki, Kawasaki (JP); Kouki Murakami, Kawasaki (JP); Hidehiko Hizuka, Kawasaki (JP)

(73) Assignee: FUJITSU LIMITED, Kawasaki-shi (JP)

(21) Appl. No.: 12/872,142

(22) Filed: Aug. 31, 2010

(30) Foreign Application Priority Data
Sep. 2, 2009 (JP) 2009-203043

(51) Int. Cl. F21V 7/22

(52) U.S. Cl. 362/606

(57) ABSTRACT

An illumination panel includes: a light-collecting section for collecting light emitted from a light source; an optical guide for optically guiding the light collected by the light-collecting section in a direction away from the light source; and a radiation section for radiating the light optically guided by the optical guide; wherein the optical guide has a plurality of grooves for reflecting the light optically guided by the optical guide to the radiation section.

### CROSS-REFERENCE TO RELATED APPLICATION

This application is based upon and claims the benefit of priority of the prior Japanese Patent Application No. 2009-203043 filed on Sep. 2, 2009, the entire contents of which are incorporated herein by reference.

### FIELD

The embodiments discussed herein are related to an illumination panel.

### BACKGROUND

With the technological advancement in light-emitting diodes (referred to as “LEDs” hereinafter), many types of electronic apparatuses are provided with LEDs as radiation sections that perform illuminated display. For example, in a portable terminal apparatus, such as a portable telephone, a part of a housing thereof is sometimes provided with a radiation section that displays various kinds of light colors or patterns for informing the user of an incoming call or for improving the design of the apparatus. The radiation section is mainly formed of an illumination panel on a surface of the housing. Light emitted from a light source, such as an LED, arranged inside the housing is projected onto the illumination panel so as to achieve an illuminated display of various kinds of light colors or patterns.

If the radiation section has a relatively small area, a single LED is often used as the light source. However, for improving visibility or design, it is desirable to give the radiation section a relatively large area. When the radiation section has a relatively large area, the light emitted from the single LED cannot reach the entire radiation section. Therefore, when the radiation section extends over a wide area, a structural design, such as providing a plurality of LEDs as light sources, is required.

A configuration example of a radiation section of a portable terminal apparatus is shown in FIG. 10. FIG. 10 is a cross-sectional view of the radiation section and its surrounding area in the portable terminal apparatus. As shown in FIG. 10, four LEDs 10a to 10d are arranged on a substrate, and light emitted from the LEDs 10a to 10d is displayed on an illumination panel 30. Although the illumination panel 30 is held by a nontransparent holding member 20, the holding member 20 has window holes 20a to 20d formed at positions corresponding to the LEDs 10a to 10d. Therefore, the light emitted from the LEDs 10a to 10d passes through the window holes 20a to 20d so as to be projected onto the illumination panel 30. As a result, an illuminated display can be achieved over a relatively wide area of the illumination panel 30.

Japanese Laid-open Patent Publication No. 2001-324937 is an example of related art.

### SUMMARY

However, when performing illuminated display over a wide area, there is a problem in that the number of components, such as LEDs, is increased, resulting in a complicated assembly process and an increased cost. For example, in the above-described example, four LEDs are used as light sources, meaning that the number of components is increased as compared with when a single LED is used. This results in a complicated assembly process since each of the LEDs needs to be mounted onto a substrate, as well as an increased cost for manufacturing the portable terminal apparatus.

Furthermore, when the portable terminal apparatus has waterproof performance, for example, an increased number of components can sometimes lead to deterioration of the waterproof performance. Specifically, an increased number of components means increased joint sections between components, which can lead to a higher possibility of formation of gaps between the components due to an error at the time of manufacture. Therefore, there is a higher risk of water penetration in the portable terminal apparatus, leading to deterioration of the waterproof performance. At the same time, the formation of gaps between the components due to an increased number of components can also result in reduced strength of the portable terminal apparatus.

According to an aspect of the embodiment, an illumination panel includes: a light-collecting section for collecting light emitted from a light source; an optical guide for optically guiding the light collected by the light-collecting section in a direction away from the light source; and a radiation section for radiating the light optically guided by the optical guide; wherein the optical guide has a plurality of grooves for reflecting the light optically guided by the optical guide to the radiation section.

The object and advantages of the embodiment will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating the exterior appearance of a front-face side of a portable terminal apparatus according to an embodiment;

FIG. 2 is a perspective view illustrating the exterior appearance of a rear-face side of the portable terminal apparatus according to the embodiment;

FIG. 3 is an exploded perspective view illustrating the configuration of a movable housing according to the embodiment;

FIG. 4 is a plan view illustrating the configuration of the reverse side of a rear casing according to the embodiment;

FIG. 5 is an enlarged view illustrating a part of the rear casing according to the embodiment;

FIGS. 6A and 6B are diagrams for explaining an optical guide through which light emitted from an LED travels;

FIG. 7 is a perspective view illustrating the movable housing of the portable terminal apparatus according to the embodiment;

FIG. 8 is a schematic cross-sectional view taken along line VIII-VIII in FIG. 7;

FIG. 9 is a schematic cross-sectional view taken along line IX-IX in FIG. 7; and

FIG. 10 is a cross-sectional view illustrating a configuration example of a radiation section.

### DESCRIPTION OF EMBODIMENTS

An illumination panel and a light-emitting device according to an embodiment disclosed by the present application will be described below with reference to the drawings. The following embodiment will be described with reference to a portable terminal apparatus equipped with the light-emitting device as an example. It should be noted that the present invention is not to be limited by this embodiment.

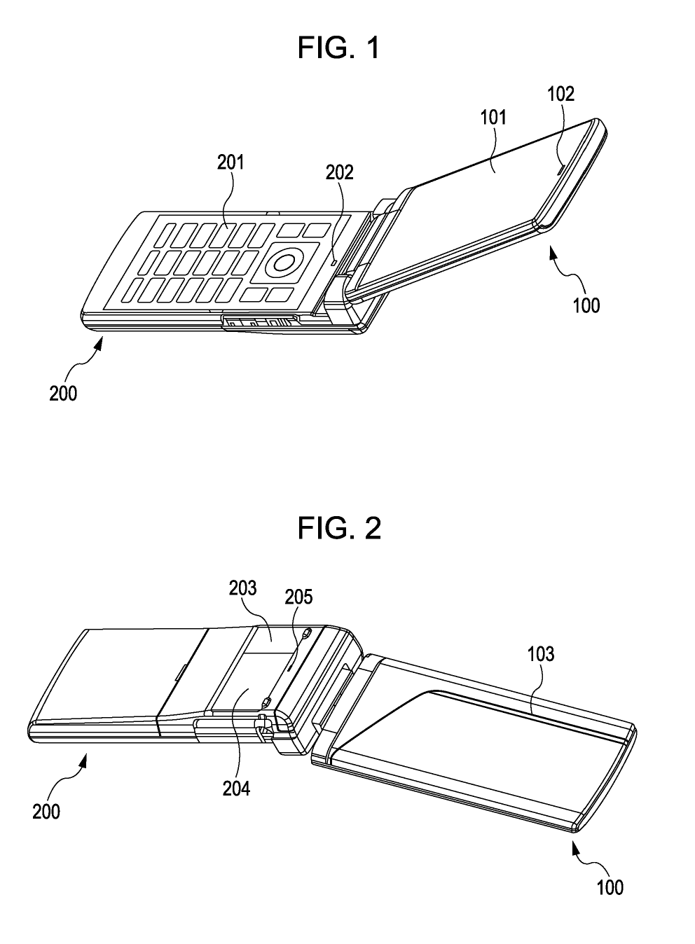

FIG. 1 is a perspective view illustrating the exterior appearance of the portable terminal apparatus according to this embodiment. As shown in FIG. 1, the portable terminal apparatus according to this embodiment is a folding-type portable telephone having a movable housing 100 and a stationary housing 200. The movable housing 100 is rotatably attached to the stationary housing 200. The movable housing 100 has a display section 101 and an opening 102. The stationary housing 200 has an operating key section 201 and an opening 202. The surfaces on which the display section 101 and the operating key section 201 shown in FIG. 1 are provided are surfaces with which a user comes into contact when making a telephone call, and these surfaces will each be referred to as “front face” hereinafter. On the other hand, the surfaces opposite the surfaces provided with the display section 101 and the operating key section 201 will each be referred to as “rear face” hereinafter.

The display section 101 includes, for example, a liquid-crystal panel. The display section 101 displays various kinds of information. In detail, the display section 101 displays, for example, a telephone number input by operating the operating key section 201.

The opening 102 is a through-hole that connects to a receiver provided inside the movable housing 100. Specifically, a receiver that produces the sound of received audio is provided inside the movable housing 100. The sound produced by the receiver can be heard through the opening 102.

The operating key section 201 accepts input operation performed by the user. In detail, the operating key section 201 accepts, for example, input operation of a telephone number that the user may desire to call, or accepts input operation for commencing or ending a telephone call.

The opening 202 is a through-hole that connects to a microphone provided inside the stationary housing 200 at the front-face side thereof. Verbal sound released by the user enters the interior of the stationary housing 200 through the opening 202 and is picked up by the microphone provided at the front-face side. The portable terminal apparatus according to this embodiment has a double microphone structure and is equipped with two microphones at the front-face side and the rear-face side, respectively. With such a double microphone structure, ambient noise can be reduced during, for example, a telephone call.

FIG. 2 is a perspective view illustrating the exterior appearance of the rear-face side of the portable terminal apparatus according to this embodiment. As shown in FIG. 2, the rear face of the movable housing 100 is provided with a radiation section 103. On the other hand, a camera section 203, a fingerprint sensor section 204, and an opening 205 are arranged on the rear face of the stationary housing 200.

As will be described later, the radiation section 103 is formed in a transparent rear casing that partly constitutes the movable housing 100. The radiation section 103 is illuminated with light emitted from an LED provided inside the movable housing 100. For example, when receiving an incoming call, the radiation section 103 displays a predetermined light color or a predetermined pattern for informing the user of the incoming call.

The camera section 203 includes a camera for image acquisition. The camera section 203 acquires an image in response to user's operation performed via the operating key section 201. The fingerprint sensor section 204 includes a fingerprint sensor for user authentication. The fingerprint sensor section 204 identifies the user by reading the user's fingerprint and determines whether or not to permit the use of the portable terminal apparatus.

The opening 205 is a through-hole that connects to the microphone provided inside the stationary housing 200 at the rear-face side thereof. Verbal sound released by the user enters the interior of the stationary housing 200 not only through the aforementioned opening 202 but also through the opening 205, and is picked up by the microphone provided at the rear-face side.

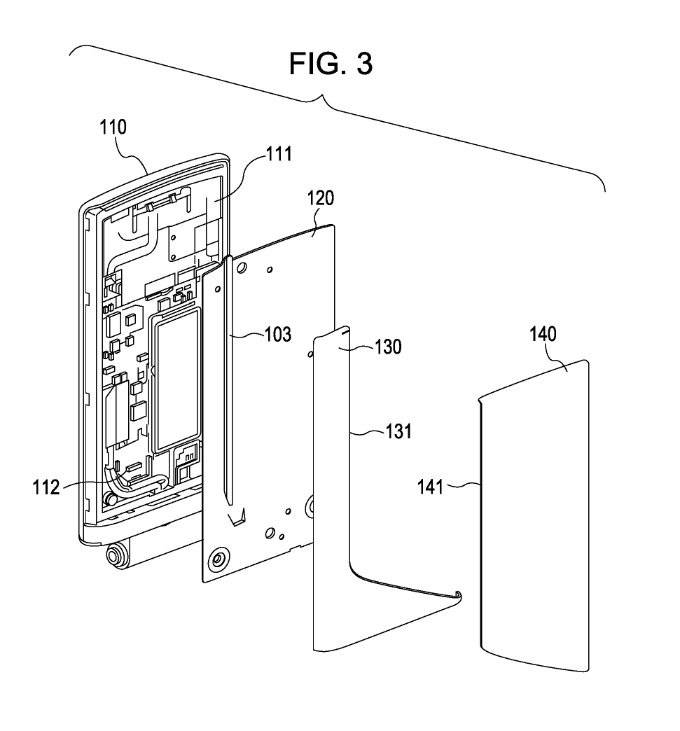

FIG. 3 is an exploded perspective view illustrating the configuration of the movable housing 100. As shown in FIG. 3, a surface of the movable housing 100 is constituted of a front casing 110, a rear casing 120, a first exterior panel 130, and a second exterior panel 140.

The front casing 110 secures a substrate 111 in position. An LED 112 is arranged in the substrate 111. The LED 112 is a light source for emitting light. The display section 101 and the opening 102 shown in FIG. 1 are formed on the front-face side (not shown) of the front casing 110.

The rear casing 120 functions as an illumination panel made of a transparent material. The rear casing 120 is joined to the front casing 110 such that the substrate 111 equipped with the LED 112 is housed between the rear casing 120 and the front casing 110. When joined to the front casing 110, the rear casing 120 is provided with the radiation section 103 that extends longitudinally from a position near the LED 112. The radiation section 103 extends in the longitudinal direction of the rear casing 120. The substrate 111 has a single LED 112 arranged therein. As will be described later, in this embodiment, an optical guide that allows light emitted from the LED 112 to efficiently reach the entire radiation section 103 is formed on the reverse side of the rear casing 120.

The first exterior panel 130 and the second exterior panel 140 are resinous panels with different colors. The exterior panels 130 and 140 are fixed to the rear face of the rear casing 120. In this embodiment, the exterior panels 130 and 140 are attached to the rear casing 120 such that the radiation section 103 is exposed through a gap between an edge 131 of the first exterior panel 130 and an edge 141 of the second exterior panel 140.

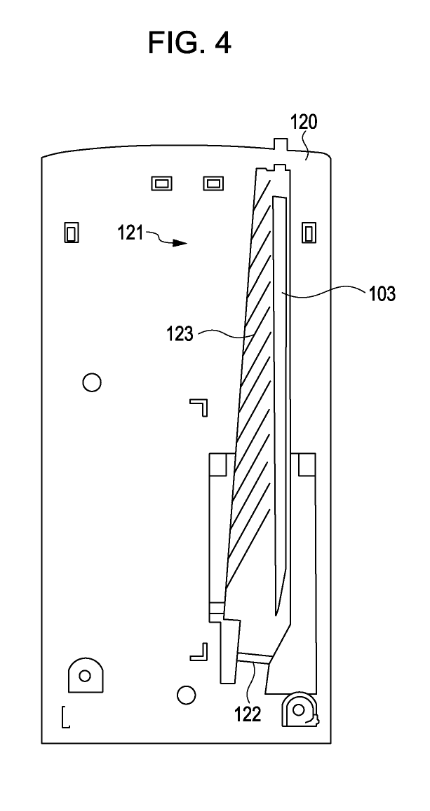

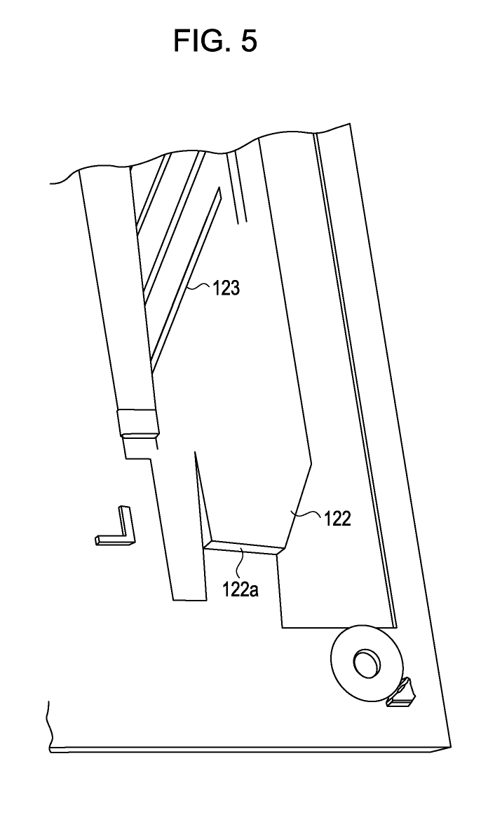

FIG. 4 is a plan view illustrating the configuration of the reverse side of the rear casing 120. As shown in FIG. 4, the reverse side of the rear casing 120 is provided with an optical guide 121 formed along the radiation section 103, and a light-collecting section 122 is provided at a position of the optical guide 121 that corresponds to the LED 112. The optical guide 121 has a plurality of reflective grooves 123 extending slantwise relative to the traveling direction of light entering the optical guide 121 from the light-collecting section 122.

The optical guide 121 extends along the radiation section 103 in a direction away from the LED 112. The light from the LED 112 enters the optical guide 121 via the light-collecting section 122 formed at one end of the optical guide 121 so as to be projected onto the entire radiation section 103. The optical guide 121 optically guides the light from the LED 112 in the extending direction of the radiation section 103. The reflective grooves 123 in the optical guide 121 reflect a portion of the light toward the radiation section 103. With the reflected light, an illuminated display is achieved in the radiation section 103. The optical guide 121 has a shape that is wide near the light-collecting section 122 and tapers with increasing distance from the light-collecting section 122 arranged at the position corresponding to the LED 112. Thus, the light entering the optical guide 121 from the light-collecting section 122 becomes concentrated in a narrower region as the light travels toward a terminal end of the optical guide 121, thereby compensating for a reduction of light intensity caused by attenuation.

The light-collecting section 122 protrudes from the reverse side of the rear casing 120 so as to cover the light emission range of the LED 112 when the front casing 110 and the rear casing 120 are joined to each other. The protruding portion of the light-collecting section 122 collects the light from the LED 112 and makes the light enter the optical guide 121. Because the light-collecting section 122 covers the light emission range of the LED 112, the light emitted from the LED 112 serving as a light source is prevented from being scattered outward from the optical guide 121, thereby preventing a loss of light.

The reflective grooves 123 formed in the optical guide 121 are substantially parallel to each other. The reflective grooves 123 reflect the light entering the optical guide 121 from the light-collecting section 122 and project the light onto the radiation section 103. The reflective grooves 123 are depressions formed in the reverse side of the rear casing 120. A portion of the light traveling through the optical guide 121 is reflected toward the radiation section 103 by being incident on the reflective grooves 123. Because the reflective grooves 123 are formed substantially parallel to each other, the reflected light traveling toward the radiation section 103 can be made uniform. Furthermore, the reflective grooves 123 extend slantwise and away from the light-collecting section 122 as they approach the radiation section 103 so that the light reflected by the reflective grooves 123 is made to travel toward the radiation section 103. An angle formed between the traveling direction of the light optically guided by the optical guide 121 and the extending direction of the reflective grooves 123 is equal to an angle formed between the traveling direction of the light reflected by the reflective grooves 123 and the extending direction of the reflective grooves 123. Consequently, the light traveling through the optical guide 121 is reflected by the reflective grooves 123 by a reflection angle that is equal to an incidence angle of the light, before being projected onto the radiation section 103.

The reflective grooves 123 can be deeper with increasing distance from the light-collecting section 122. The deeper the reflective groove, the larger the amount of the reflection of light is. The further from the light-collecting section 122, the larger the amount of attenuation of light is. The amount of the light reflected to the radiation section 103 can be adjusted by changing the depth of the reflective groove in accordance with the distance from the light-collecting section 122.

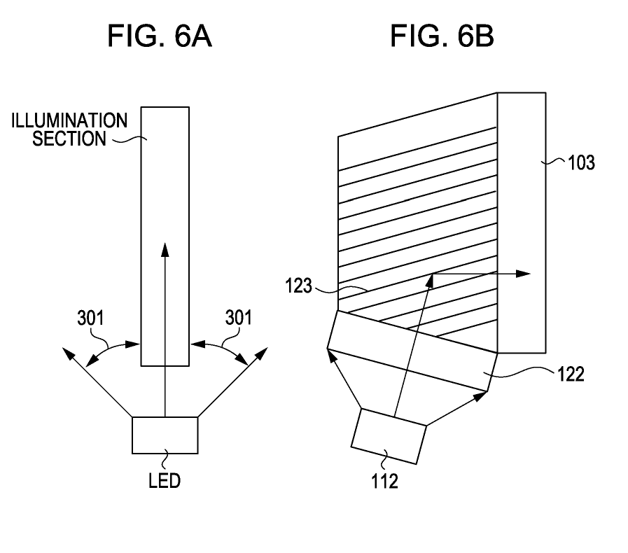

Next, the configuration of the light-collecting section 122 will be described in more detail with reference to FIG. 5 and FIGS. 6A and 6B. FIG. 5 is an enlarged view illustrating a part of the rear casing 120. As shown in FIG. 5, the light-collecting section 122 includes a light-collecting surface 122a that protrudes from the reverse side of the rear casing 120 and that is formed to cover the light emission range of the LED 112. Furthermore, in plan view, the light-collecting section 122 has a trapezoidal shape that becomes wider with increasing distance from the light-collecting surface 122a. The light-collecting section 122 allows the light emitted from the LED 112 to enter the optical guide 121 via the light-collecting surface 122a.

FIGS. 6A and 6B are diagrams for explaining an optical guide through which light emitted from an LED travels. FIG. 6A illustrates a configuration for introducing the light emitted from the LED directly to the radiation section. As shown in FIG. 6A, in the configuration for introducing the light emitted from the LED directly to the radiation section, the light emitted from the LED is scattered to regions 301 other than the radiation section, resulting in a loss of light projected onto the radiation section. Although a light-emitting surface of the LED emits light to a certain light emission range, the light traveling toward the regions 301 cannot be utilized for illuminated display especially when the radiation section has a small width, resulting in a loss of light.

FIG. 6B illustrates a configuration for introducing the light emitted from the LED 112 to the light-collecting section 122 in this embodiment. As shown in FIG. 6B, the light-collecting section 122 has the light-collecting surface 122a that covers the light emission range of the LED 112. The light-collecting surface 122a collects the entire light emitted from the LED 112 without scattering the light. The light collected by the light-collecting surface 122a is projected onto the radiation section 103 via the reflective grooves 123. Consequently, the light emitted from the LED 112 serving as a light source is efficiently projected onto the radiation section 103, thereby preventing a loss of light.

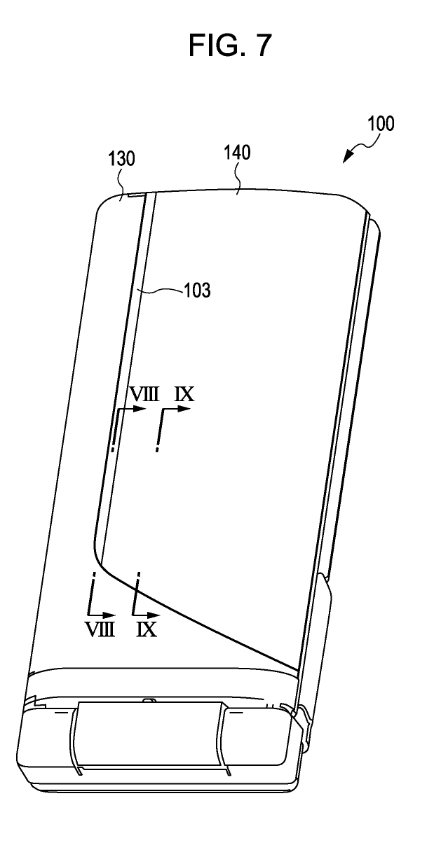

Next, a cross-sectional structure of the radiation section 103 and its surrounding area in the portable terminal apparatus according to this embodiment will be described with reference to FIG. 7 to FIG. 9. FIG. 7 is a perspective view illustrating the movable housing 100 according to this embodiment. As shown in FIG. 7, the rear face of the movable housing 100 is mainly constituted of the first exterior panel 130 and the second exterior panel 140. The radiation section 103 provided in the rear casing 120 is exposed through the gap between the first exterior panel 130 and the second exterior panel 140.

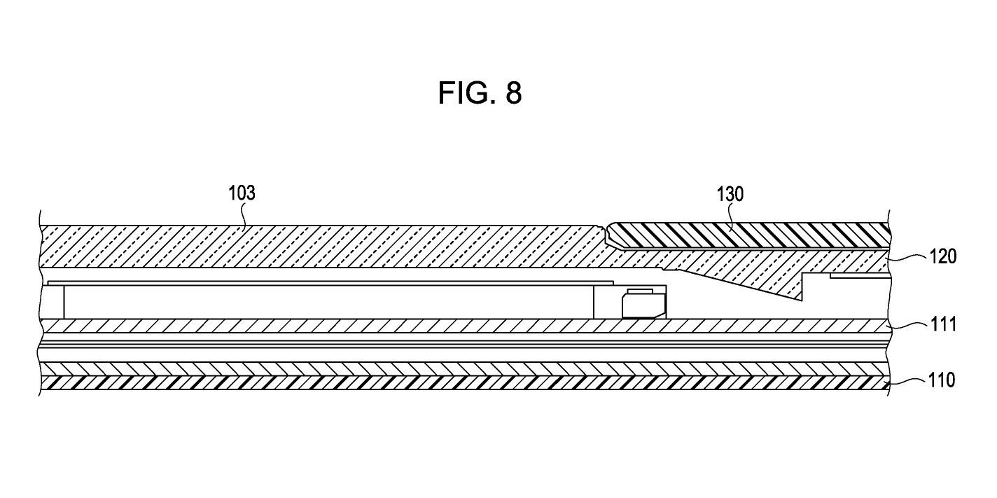

FIG. 8 is a schematic cross-sectional view taken along line VIII-VIII in FIG. 7. FIG. 8 illustrates the cross section of the movable housing 100 taken along line VIII-VIII through the radiation section 103. As shown in FIG. 8, in the cross section taken along line VIII-VIII, the front casing 110 as well as the radiation section 103 and the first exterior panel 130 of the rear casing 120 constitute an outer shell of the movable housing 100. The movable housing 100 has the substrate 111 therein. Although not shown in FIG. 8, a reflective film that reflects light may be attached to the surface of the rear casing 120 that faces the substrate 111 so as to prevent a leakage of light from areas other than the radiation section 103.

In this embodiment, the LED 112 is not arranged at a position on the substrate 111 that faces the radiation section 103. The radiation section 103 displays the light emitted from the LED 112 (not shown in FIG. 8) and projected from the optical guide 121. The illuminated display in the radiation section 103 can be changed to various forms in accordance with the color and the pattern of the light emitted from the LED 112.

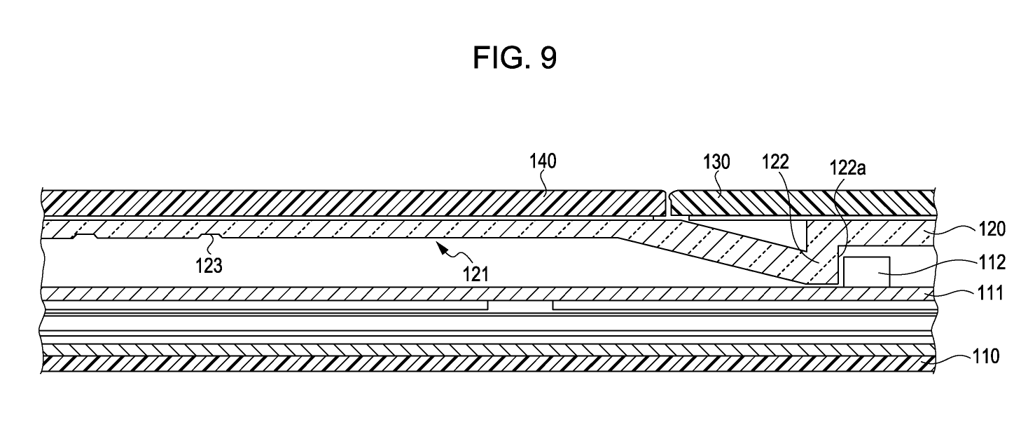

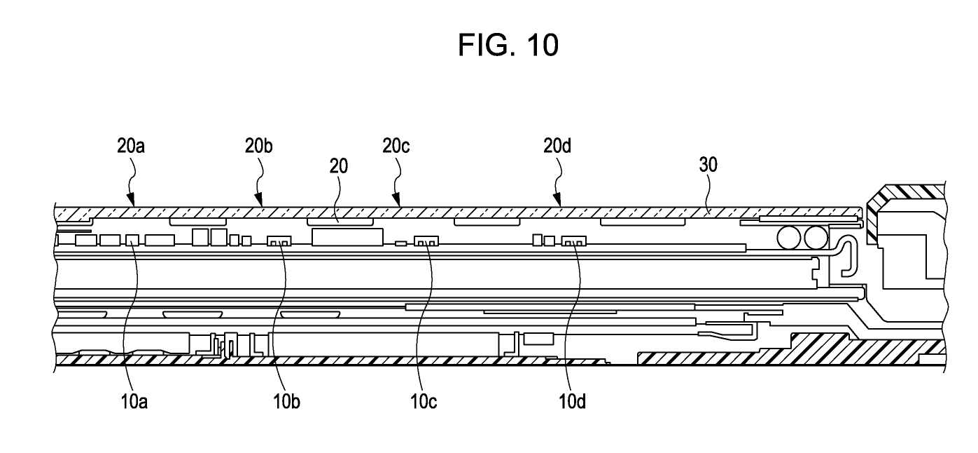

FIG. 9 is a schematic cross-sectional view taken along line IX-IX in FIG. 7. FIG. 9 illustrates the cross section of the movable housing 100 taken along line IX-IX through the optical guide 121. As shown in FIG. 9, in the cross section taken along line IX-IX, the front casing 110 as well as the first exterior panel 130 and the second exterior panel 140 constitute the outer shell of the movable housing 100. The substrate 111 arranged inside the movable housing 100 has the LED 112.

The rear casing 120 is attached to the reverse side of the first exterior panel 130 and the second exterior panel 140. The rear casing 120 forms the optical guide 121. The light-collecting section 122 that collects the light emitted from the LED 112 is formed adjacent to the LED 112. The optical guide 121 that optically guides the collected light toward the radiation section 103 extends from the light-collecting section 122. In the light-collecting section 122, the light-collecting surface 122a protrudes from the reverse side of the rear casing 120 and faces the LED 112. The light-collecting surface 122a collects the light emitted from the LED 112 without scattering the light.

The optical guide 121 is provided with the reflective grooves 123 formed as depressions in the reverse side of the rear casing 120. The reflective grooves 123 extend slantwise relative to the course of light traveling through the optical guide 121. By reflecting a portion of the light traveling through the optical guide 121, the reflective grooves 123 project the light toward the radiation section 103 in the cross section taken along line VIII-VIII. As mentioned above, a reflective film may be attached to the surface of the rear casing 120 that faces the substrate 111. Moreover, regarding the surface of the rear casing 120 that is in contact with the first exterior panel 130 and the second exterior panel 140, a reflective film may similarly be attached to an area of the surface other than the radiation section 103. In this manner, since light traveling outward from the optical guide 121 can be returned to the interior of the optical guide 121 by the reflective films, a light leakage can be prevented, thereby minimizing a loss of light.

Accordingly, in this embodiment, the light-collecting section 122 that collects the light from the LED 112, the optical guide 121 that optically guides the collected light, and the radiation section 103 that displays the optically guided light are all formed in the rear casing 120. Therefore, an illuminated display can be achieved by providing a layer for the rear casing 120 in the movable housing 100, thus preventing an increase of the number of components required for the illuminated display. As a result, a risk of, for example, water penetration between components is reduced, thereby preventing deterioration of waterproof performance of the portable terminal apparatus as well as increasing the strength thereof. Furthermore, since the light emitted from the LED 112 is optically guided by the optical guide 121 and is projected onto the radiation section 103 via the reflective grooves 123, light from a single light source can be displayed over a relatively wide area. Therefore, the number of LEDs can be minimized, thereby preventing a complicated assembly process and an increased cost of the portable terminal apparatus.

According to this embodiment, the rear casing made of a transparent material is configured to collect the light from the light source, optically guide the collected light in the direction in which the radiation section extends, and reflect a portion of the light by using the reflective grooves extending slantwise relative to the traveling direction of the light, thereby achieving an illuminated display. Therefore, the light emitted from a single light source can be efficiently displayed over a wide area, and the number of components used for the illuminated display is not increased. In other words, a wide-area illuminated display can be achieved while an increase of the number of components is prevented.

Although the above-described embodiment is directed to a description of an illuminated display in a movable housing of a folding-type portable telephone, the above-described advantages can be achieved with respect to an illuminated display in various electronic apparatuses by providing an illumination panel having a similar configuration to that of the aforementioned rear casing. Specifically, by providing an illumination panel having a similar configuration to that of the aforementioned rear casing in, for example, a light-emitting device provided in a housing of a notebook-size personal computer, an increase of the number of components in the notebook-size personal computer can be prevented and the strength of the housing can be increased.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An illumination panel comprising:
a light-collecting section for collecting light emitted from a light source;
an optical guide for optically guiding the light collected by the light-collecting section in a direction away from the light source; and
a radiation section for radiating the light optically guided by the optical guide, the radiation section extending along the optical guide;
wherein the optical guide has a plurality of grooves for reflecting the light optically guided by the optical guide to the radiation section.

2. The illumination panel of claim 1, wherein the light-collecting section includes light-collecting surface for covering a light emission range of the light source, and guides the light emitted from the light source to enter the optical guide via the light-collecting surface.

3. The illumination panel of claim 1, wherein the reflective grooves are substantially parallel to each other.

4. The illumination panel of claim 1, wherein the optical guide tapers with increasing distance from the light-collecting section.

5. The illumination panel of claim 1, wherein the reflective grooves are deeper with increasing distance from the light-collecting section.

6. A light-emitting device comprising:
a light source for emitting light;
a light-collecting section for collecting light emitted from a light source;
an optical guide for optically guiding the light collected by the light-collecting section in a direction away from the light source; and
a radiation section for radiating the light optically guided by the optical guide;
wherein the optical guide has a plurality of grooves for reflecting the light optically guided by the optical guide to the radiation section.

7. The light-emitting device of claim 6, further comprising a reflective film for reflecting a light traveling outward from the optical guide to the interior of the optical guide.

8. A portable terminal apparatus having a first case for fixing a substrate arranged a light source for emitting light and a second case for housing the substrate by jointing to the first case, the second case comprising:
a light-collecting section for collecting light emitted from the light source;
an optical guide for optically guiding the light collected by the light-collecting section in a direction away from the light source; and
a radiation section for radiating the light optically guided by the optical guide;
wherein the optical guide has a plurality of grooves for reflecting the light optically guided by the optical guide to the radiation section.
